(19) United States
(12) Patent Application Publication
(10) Pub. No.: US 2016/0042457 A1
(43) Pub. Date: Feb. 11, 2016

(54) SYSTEM AND METHOD FOR CONDUCTING A REAL ESTATE AUCTION IN A NETWORK

(71) Applicant: Realquidity Corp., San Mateo, CA (US)

(72) Inventors: Shawn Aubrey Silk, Burlingame, CA (US); Harris Krumwiede Ross, San Carlos, CA (US); Quinn Michael McLaughlin, Santa Cruz, CA (US); Robin Leiman, Palo Alto, CA (US); Allen Blankenship, San Mateo, CA (US)

(73) Assignee: Realquidity Corp., San Mateo, CA (US)

(21) Appl. No.: 14/819,776

(22) Filed: Aug. 6, 2015

Related U.S. Application Data
(60) Provisional application No. 62/034,012, filed on Aug. 6, 2014.

(51) Int. Cl. G06Q 40/04; G06Q 50/16

(52) U.S. Cl. CPC G06Q 40/04; G06Q 50/16

(57) ABSTRACT

Embodiments described herein include a network-based exchange for conducting transactions involving fractional interests in real estate assets. The platform acts as both a market where participants can buy and sell fractional interests in real estate properties and a funding mechanism where entrepreneurial real estate promoters can raise capital through a private market. The platform enables a large group of underserved accredited investors to invest in commercial real estate. The system can receive bids over the network for purchase of one or more of the fractional interests from buyers and determine highest bidders for each fractional interest. Successful buyers can then be identified for each fractional interest when the highest bidder bids an amount that meets or exceeds a reserve price set by the seller. Ownership of a fractional interest in the real estate asset includes the right to a proportional amount of income generated by the fractional interest.

### CROSS-REFERENCE TO RELATED APPLICATIONS

This application claims the benefit of U.S. Provisional Application No. 62/034,012, filed Aug. 6, 2014, which is incorporated herein by reference in its entirety.

### FIELD OF THE INVENTION

At least certain embodiments of the invention relate generally to real estate financing, and more particularly to an online system for conducting real estate transactions.

### BACKGROUND OF THE INVENTION

Today's real estate market is one characterized by opaqueness and difficulty in finding information. Identifying market-favorable real estate investments is a challenge for the experienced real estate investor, let alone an ordinary or casual investor. Most successful investors identify opportunities through the cultivation of a network of information providers that may include banks, real estate brokers, asset managers, project managers and general contractors. For individuals who spend their working time in the real estate field, this is a challenge that takes time. For the balance of the investment community, this is a nearly impossible task. In addition to the high capital demands that commercial real estate investing requires, it is also generally illiquid. Often, the most rapid path to liquidity is a financing event in which an owner places debt against a subject property. This occurs in many cases because owners do not want to sell their property due to the risk of losing appreciation, shrinking their balance sheet, adverse tax impacts, or reinvestment risks.

There is currently no way for owners to maintain their real estate investments while capitalizing on the value of their property or to hedge their real estate investments by taking profits or losses on portions of it. If an owner wishes to sell a portion of their ownership interest in real estate assets, no market currently exists other than one's network of friends or family. Sellers today generally utilize real estate brokerage firms when attempting to sell their assets. Where a brokerage firm is not used, the seller is engaging in an off-market transaction that goes to a favored buyer, or to a buyer that the seller hopes offers some benefit, e.g., above-market pricing, or quick close. When a listing is taken to market, the seller is dependent on the broker's network. But such a network always fails to tap into the many global investors that don't invest with well-known real estate asset management funds.

Only institutions of considerable means, such as banks, corporations, real estate investment trusts (“REITS”), pensions, endowments, or high-net worth private investors, have the financial means to buy, sell, or trade high-value real estate assets. It is possible for groups of individuals to combine together in order to make joint purchases or investments in commercial real estate assets through the formation of syndicates, collectives, funds and the like, but such group purchases generally require all parties to reach agreement in advance regarding the legal and financial structures involved. Entities such as general partnerships, limited partnerships (“LPs”), limited liability companies (“LLCs”), and corporations also invest in commercial real estate. But participation in such entities generally requires a substantial investment that is beyond the means of many ordinary investors. Moreover, partners in a LP, non-managing members of an LLC, or shareholders in a corporation have little or no say in the property acquisition choices of the entity. Furthermore, equity in such entities is generally not liquid. Thus there are many real estate property owners with untapped equity in their assets, particularly in the markets where real estate properties have appreciated significantly. What is needed is a marketplace where ordinary investors can acquire interests in commercial real estate assets and be able to easily liquidate those assets as desired.

An investor with limited funds may wish to diversify his or her investment portfolio by investing in fractional (i.e., partial) ownership of several real estate properties. Private real estate partnerships have historically been one avenue for fractional direct investment in real estate assets; however, such partnerships typically involve excessive general partner fees and require limited partners to relinquish part of the future upside associated with their investment. Most investor's only alternative for investing in fractional interests of real estate properties is investing in a REIT. A REIT is a real estate investment organization that finds investors, buys real property, and gives each investor either a percentage interest in the fund or an interest in a loan secured by a mortgage or deed of trust on the property. When the property is sold or the mortgage repaid, there is a division of profits. But REIT returns rarely mimic direct real estate investment returns. REITs are also subject to volatility of the stock market, dilution from stock options and secondary offerings, and decision-making that often benefits the near-term stock price of the company rather than the long-term interests of stockholders. In addition, as an entity whose primary function is to pass profits onto investors, the business activities of a REIT are generally restricted to generation of property rental or mortgage income. REITs do not allow real estate property owners to buy and sell or trade fractional interests in real estate assets; nor do they allow investors to choose their own mix of real estate properties. Consequently, investing in a REIT is more akin to investing in a mutual fund, rather than buying stocks. Indeed, it has been observed that prices of REIT shares are correlated with stock markets to a greater extent than with the real estate markets.

Presently there is no market for ordinary investors of limited means to buy, sell and trade fractional interests in commercial real estate assets in a manner similar to the way they invest in shares of stock of companies listed on the various public exchanges. As a result, investors in today's real estate marketplace have virtually no options available to acquire interests in real estate assets in a low cost and efficient manner. This results in inexact and inefficient pricing and opportunity for both buyers and sellers.

### SUMMARY

Embodiments of the invention described herein include a network-based exchange for conducting transactions involving fractional interests in real estate assets. The system can receive bids over the network for purchase of one or more of the fractional interests from buyers and determine highest bidders for each of the fractional interests. Successful buyers can then be identified for each fractional interest when the highest bidder bids an amount that meets or exceeds the reserve price set by the seller. Ownership of a fractional interest in the real estate asset includes the right to a proportional amount of income generated by the fractional interest.

### BRIEF DESCRIPTION OF THE DRAWINGS

For a better understanding of at least certain embodiments, reference will be made to the following detailed description, which is to be read in conjunction with the accompanying drawings, wherein:

FIG. 1 depicts an example block diagram of one embodiment of a system for conducting a real estate auction in a network.

FIG. 2 depicts an example block diagram of one embodiment of a computer server for conducting a real estate auction in a network.

FIGS. 3A-3C depict example flow charts of one embodiment of a method for conducting a real estate auction in a network.

FIGS. 4-5 depict example embodiments of a graphical interface for collecting information for sales transactions.

FIG. 6 depicts an example embodiment of a graphical interface for displaying information relating to a real estate asset for sale.

FIG. 7 depicts an example embodiment of a graphical interface for displaying more detailed information relating to a real estate asset for sale.

FIG. 8 depicts an example embodiment of a graphical interface for collecting buyer profile information.

FIG. 9 depicts an example embodiment of a graphical interface for collecting buyer preferences information.

FIG. 10 depicts an example embodiment of a graphical interface for collecting buyer accreditation information.

FIG. 11 depicts an example embodiment of a graphical interface for collecting bidding information.

FIG. 12 depicts an example embodiment of a user account dashboard interface.

FIG. 13 depicts an example data processing system upon which the embodiments described herein may be implemented.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

Systems and methods for conducting an online real estate auction are described herein. At least certain embodiments include a network-based exchange for conducting real estate transactions. The exchange acts as both a market where participants can buy and sell fractional interests in real estate properties and a funding mechanism where entrepreneurial real estate promoters can raise capital through a private market. The system is configured for buying and selling of real estate assets at a fractional level over one or more networks to enable multiple buyers to participate in real estate purchases. Such a platform brings the ability to invest in commercial real estate to a large group of underserved accredited investors; it effectively democratizes a traditionally high capital-intensive investment arena, and creates transparency in a traditionally opaque market.

The systems and methods described herein connect buyers and sellers for real estate transactions using a modality similar to “crowdfunding. The term “crowdfunding” as used herein refers to the practice of funding a project or venture by raising multiple small amounts of money from a large number of people, typically via the Internet. The interests in the real estate assets for sale can be subdivided into multiple fractional interests and sold on a network-based exchange. This enables multiple users to access an online real estate marketplace containing information on pricing and investment opportunities for real estate assets. Users can make offers to buy and sell or invest in fractional interests in real estate assets utilizing smaller amounts of capital. In one embodiment, the interests in the real estate assets sold using the system can be less than 100%.

At the outset, an offer for sale of a prescribed number of fractional interests in a real estate asset can be received by the system. The offer generally includes an initial price or price range for the fractional interests. Then, any investor who is interested in the offering can place a bid in the auction through a website or application on a mobile device. The system receives bids for purchase of one or more of the fractional interests and identifies successful bidders. The system determines whether oversubscription occurred. Oversubscription occurs when offers for purchase of the fractional interests at or above the seller's reserve price exceed the prescribed number of fractional interests being offered for sale. That is, an oversubscription occurs when there are more interested buyers making bids at or above the reserve price than there are fractional interests available in the offering.

When an oversubscription occurs, the system is configured to conduct an online auction to receive bids for the fractional interests. In an embodiment, the fractional interests are sold at the seller's reserve price when oversubscription has not occurred and are sold at the clearing price based on bids received when oversubscription has occurred. Bids include the number and purchase price of fractional interests to be purchased. That is, bids include the number of fractional interests a potential purchaser would be willing to purchase and the price per fractional interest such potential purchaser would be willing to pay. Bidders may also be permitted to increase number and purchase price of fractional interests bid for during the auction period (e.g., predetermined period of time), which may be referred to herein as the subscription period. Bidding can be held open for a predetermined period of time (subscription period) or until the reserve price for each fractional interest is met or exceeded. The time remaining for bidding on the fractional interests can be displayed to users in a graphical interface.

Once the auction is closed, the system calculates a fair market clearing price based on a mathematical model. In an embodiment, the fractional interests are sold to successful bidders at the clearing price when oversubscription has occurred and to successful bidders at the reserve price when oversubscription has not occurred. In one embodiment, the reserve price is based on the value of the real estate asset and the number of fractional interests being offered. In other embodiments the reserve price is based on a minimum amount of capital to fundraise. The reserve price is a price range in which bids must be within, or a minimum price bids must be above. The reserve price is based on the value of the real estate asset and the number of fractional interests being offered.

The system is adapted to cause listings of interests in real estate assets for sale to be displayed to users in a graphical interface. The graphical interface can be a web-based or application-based interface. The asking price, annual revenue, and net income for the multiple fractional interests can be displayed to users. The system may also display the total capital pledged during an open subscription period, amount over the maximum capital, amount of subscription filled, or whether the minimum capital raise has been met.

Offers for sale of an interest in a real estate asset are received at a data processing server in the network(s) configured to process real estate transaction information. The system can then receive offers for purchase of one or more of the fractional interests from buyers through a network interface in communication with the network(s).

In one embodiment, after closing bidding on the fractional interests the system determines the highest bidders for each of the fractional interests. Successful bidders can then be identified for each fractional interest as long as each highest bidder bids an amount that meets or exceeds a reserve price set by the seller. The reserve price may be unknown to the buyers during the bidding process. The system is configured to calculate an average selling price for the fractional interests as well as a final selling price. A clearing price for purchase of the fractional interests is set equal to the average selling price, and the final selling price is calculated by adding up the clearing prices for all of the fractional interests in the offering.

From the final selling price, the system can allocate a pro rata share of the interest in the real estate asset for sale to each successful bidder based on the proportional amount each bidder contributes to the final selling price. In this embodiment, successful bidders are granted fractional interests of varying sizes based on each buyer's pro rata share. Highest bidders who submit bids greater than the clearing price of the fractional interests are granted a final fractional interest greater than the initial prescribed fractional interests, and highest bidders who submit bids less than the clearing price of the fractional interests are granted a final fractional interest less than the initial prescribed fractional interests. Ownership of a fractional interest in the real estate asset includes the right to a proportional amount of income generated by the fractional interest.

In an alternate embodiment, after closing, the auction engine ranks bids from highest price to lowest price and based on order received for bids of equal price. Starting with the highest priced bid, the amount of fractional interests requested accumulates. The fractional interests bid for are then accumulated to each successive bid in descending rank order starting from highest price until all the fractional interests being offered for sale have been accumulated. The clearing price can then be set at the price equal to the price of the last fractional interest to be accumulated. Everyone who bids above the clearing price receives a full allocation. Everyone who bids at the clearing price can receive a full or partial allocation of fractional interests depending on how many fractional interests are outstanding and the time when order(s) were placed. The resulting fractional interests are allocated based on the actual per fractional interest price they are willing to pay.

In addition, the highest bidders can choose to either (1) receive the fractional interests they bid for at the clearing price or (2) they can be granted the option to purchase the maximum number of fractional interests their associated total purchase price can buy. For option (1), bidder deposits above the clearing price can be refunded. Bidders can also be permitted to increase number and purchase price of fractional interests bid for while the auction is open to receive bids (during the subscription period).

In an embodiment, the deed to the interest in the real estate asset is held in a holding entity, and the interest in the real estate asset is subdivided into the multiple fractional interests by subdividing the holding entity into a corresponding number of factional interests. The holding entity can be a general partnership, limited partnership, limited liability company, corporation, or real estate investment trust, etc. One purpose of holding the deed to the real estate asset(s) in a holding entity is to convert entity ownership of the whole into the multiple fractional entities that can be marketed and sold by the platform. For instance, a $1 million property can be broken into 20 interests or units, and each parcel can be offered separately until all the parcels in the property are sold. The system is able to break up real estate into fractional interests by holding the deed to the real estate asset in a corporate entity such as an LLC or LP, and then break that entity up into fractional interests. In one embodiment, the fractional interests can themselves be held in smaller sub-entities. Those smaller entities can then be offered and sold to multiple investors.

Electronic records of the details of the interest in the real estate transaction for sale as well as records of the successful buyers and transaction amounts can then be stored in a database that is accessible by the system. The database can be part of the system itself or can be operatively coupled with the system through one or more networks or interconnections. The electronic records can include, for example, a general description of the real estate asset for sale, the geographic location and address of the real estate asset, area information, number of fractional interests, purchase price and year of last purchase, information about appraisals, title insurance, and historic trading prices, as well as a data for generating a graphical representation of the real estate asset.

In at least certain embodiments, transactions on the network-based exchange for conducting an online real estate auction described herein can be conducted in real-time or near real-time. The results of transactions and the current market value of the real estate assets can also be displayed in real-time or near real-time. As used herein, the term “real-time” or “near real-time” relates to real-time computing and networking systems that are subject to a real-time constraint such as the operational time period from the occurrence of an event until the system's response to that event. Real-time systems can generally be configured to guarantee response times within strict time constraints. Real-time responses are often understood to be in the order of milliseconds, and sometimes microseconds. Conversely, a system without real-time capabilities generally cannot guarantee a response time.

Embodiments described herein further include the ability for property owners to participate in a secondary market to liquidate their real estate holdings without having to sell their property or encumber it with a mortgage. Successful buyers of one or more fractional interest in a real estate asset can further sub-divide and buy and sell their interests using the network-based real estate auction described herein. Typically, the system is configurable to only allow such sales to be processed until after the applicable securities law holding period has expired. A successful buyer's fractional interest can itself be transferred to a sub-entity and further divided into multiple fractional interests, which can then be sold to buyers on a secondary market using the system in the same manner as described above.

The advantages of the embodiments described herein are numerous. The embodiments offer value to all market participants, whether buyers, sellers or their broker representatives. First, sellers can achieve price discovery—an immediate determination of a property's current market value. Another benefit to sellers is the system connects them with qualified buyers. In an embodiment, all buyers will be qualified with money on deposit to purchase real estate interests. A third benefit to sellers is global distribution. The exchange offers a truly global reach and demand for the investment. Finally, the exchange offers seller fractional liquidity by providing a mechanism for sellers to divest all or a portion of their interests in real estate without selling an entire property. This creates the opportunity to lock-in profits and participate in future returns.

Benefits to buyers are also numerous. Buyers can achieve diversification. Buyers can become qualified through the exchange platform and be afforded the opportunity to directly invest in real estate investments and directly reap the benefits therefrom. Another benefit to buyers is reduction in barriers to entry—ordinary investors who desire to invest in real estate but do not have substantial capital can now participate in this high-value asset class (e.g., commercial real estate) by purchasing only fractional interests. Buyers can also achieve liquidity. Any investor can turn around and sell their fractional interests after expiration of the applicable securities law holding period. Finally, the platform offers buyers throughout the globe the opportunity to pool capital with other buyers through the network-based exchange.

Real estate brokers benefit from the platform as well. Commercial real estate brokers can achieve business expansion through product offerings in a totally new business line. The network-based exchange platform offers commercial real estate investors the ability to connect with real estate professionals in markets across the globe. In addition, early adopters of the system can offer their clients a differentiated product offering and sales solutions with reach beyond traditional networks.

The system can be implemented in any computer hardware, software, or combination thereof. In an embodiment, the system is implemented using a server, or similar computing system, in communication with one or more networks. Users can access the server on the network using their networked electronic devices. The server generally includes a network interface operatively coupled with the one or more processors for communicating information over the network(s). The networks can include any network type or equivalent functionality such as a local area network (“LAN”), wide area network (“WAN”), the Internet, public and private cloud-based networks, virtual networks, etc.

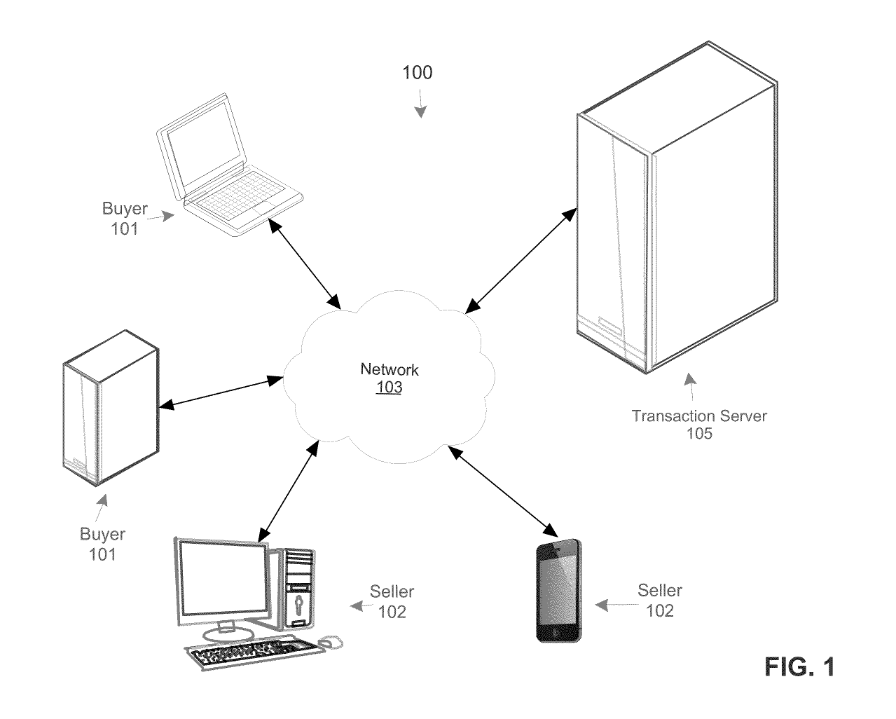

FIG. 1 depicts an example block diagram of one embodiment of a system for conducting a real estate auction in a network. In the illustrated embodiment, a system 100 includes a client-server configuration in a network well known in the art. Network 103, which can include one or more networks, connects various buyers 101 and sellers 102 with a transaction server 105. Transaction server 105 includes one or more processors operatively coupled with a system memory, as well as various network interfaces, etc. In one embodiment, server 105 can also include a transactions database (not shown) or can be communicatively coupled with a database over network 103. Transaction server 105 can be configured to perform the functionality of the network-based exchange platform described herein. Transaction server 105 can be configured to receive and display interests in real estate assets that are the subject of offers for sale from various sellers 102 over network 103. Transaction server 105 can also receive bids for purchase of those real estate assets from one or more buyers 101 over network 103 and determine successful buyers as discussed above. Transaction server 105 can be any server computer and the embodiments described herein are not limited to any particular server.

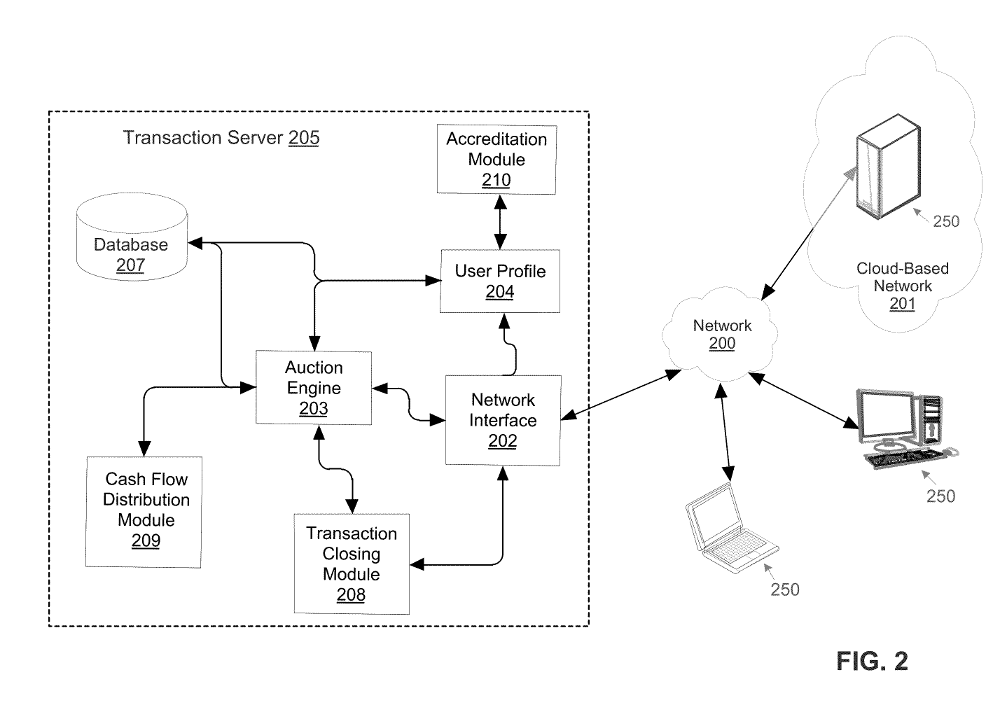

FIG. 2 depicts an example block diagram of one embodiment of a computer server for conducting a real estate auction in a network. As discussed previously, the embodiments described herein are not limited to any particular data processing system or server configuration. In the illustrated embodiment, transaction server 205 is a computer server in communication with one or more users 250 over network 200 via a network interface 202. Network 200 can include one or more networks. Users 250 generally include buyers and sellers of real estate assets and can be located at various Internet Protocol (“IP”) addresses on the network 200 or they can be virtual machines operating within a cloud-based network 201. Cloud-based computing is well known by persons of skill in the art and can include any combination of cloud-based or non-cloud based network combinations, as well as public or private cloud networks, or any combination thereof. The embodiments described herein are not limited to any particular network arrangement.

As described earlier, transaction server 205 can be utilized to operate the network-based exchange for conducting a real estate auction in accordance with the techniques described herein. In the illustrated embodiment, transaction server 205 is adapted to receive bids and other data relating to real estate transactions communicated from the users 250. Network interface 202 receives offers for sale as well as details about the corresponding interest in real estate asset(s), including the number of fractional interests to be offered and asking price. The network interface 202 can accumulate this sales information in buffering circuitry or modules and provide it to auction engine 203 for further processing and eventual storage in database 207.

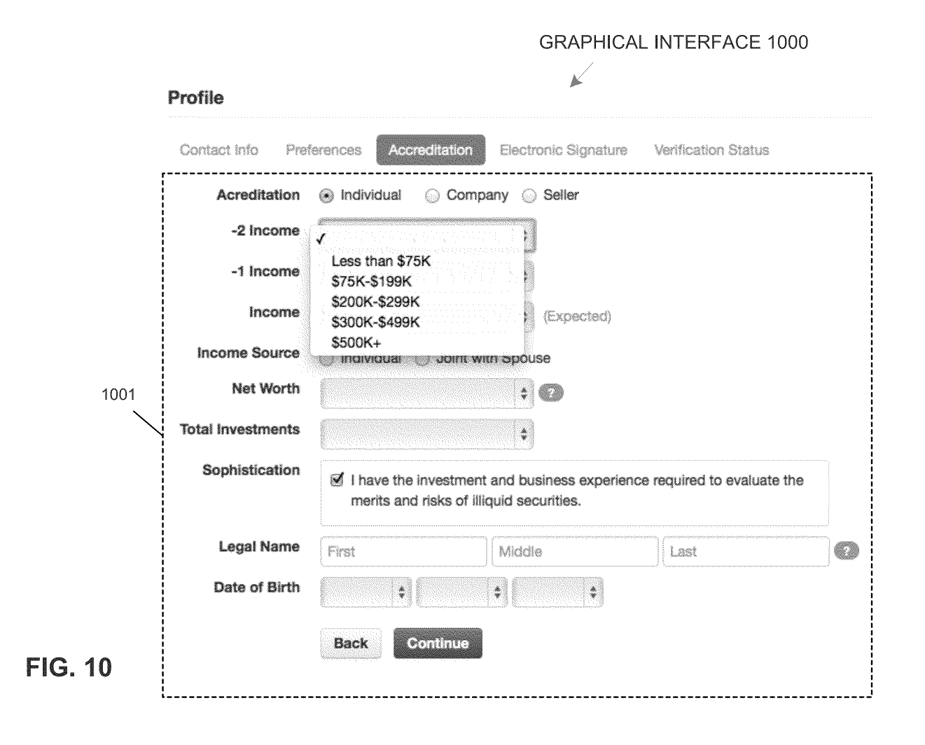

Further, an accreditation module 210 is operatively coupled with user profile module 204 to receive information to be used in determining buyer accreditation. An embodiment of a graphical interface displayed to users 250 for entering buyer accreditation information is depicted in FIG. 10 described below. Buyer accreditation information can include income, source of income, net worth, total investments, etc. This information is received by accreditation module 210 and used by the auction engine 203 to make a determination regarding buyer accreditation.

The network interface 202 is adapted to receive bids for purchase of real estate assets from one or more buyers over the network 200. The bids can similarly be accumulated in buffers within the network interface 202 and can be provided to the auction engine 203 for further processing. Auction engine 203 can then determine the highest bidders for each of the fractional interests. Once a termination event for the bidding occurs, the auction engine 203 can identify successful buyers for the fractional interests offered. In one embodiment, the termination event is the expiration of a predetermined period of time. In an alternate embodiment, the termination event can be triggered anytime a buyer meets or exceeds the reserve price for the fractional interests.

Once bidding is closed, the auction engine 203 sends a signal to the transaction closing module 208 to close the bidding process and to so notify the buyers and sellers 250. Auction engine 203 can then calculate the average selling price across all of the fractional interests. The clearing price can be set to the average selling price and the final selling price of the interest in the real estate asset for sale by adding up the clearing price for all the fractional interests for sale at transaction closing. Cash flow distribution module 209 distributes any income generated by the fractional interests to the successful buyers thereof based on their pro rata share.

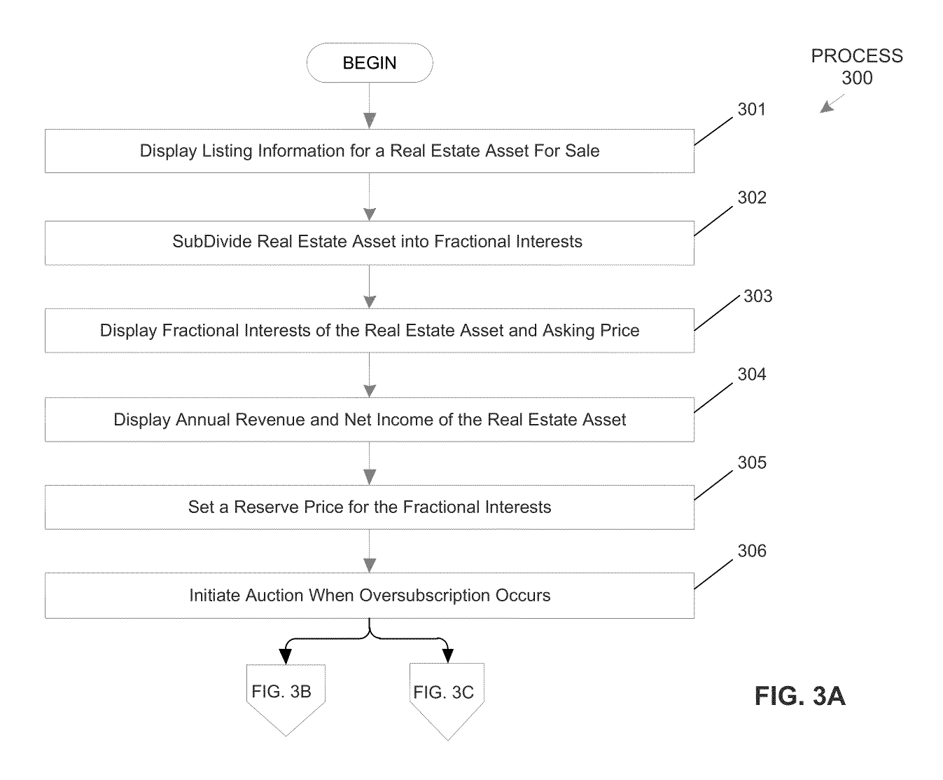

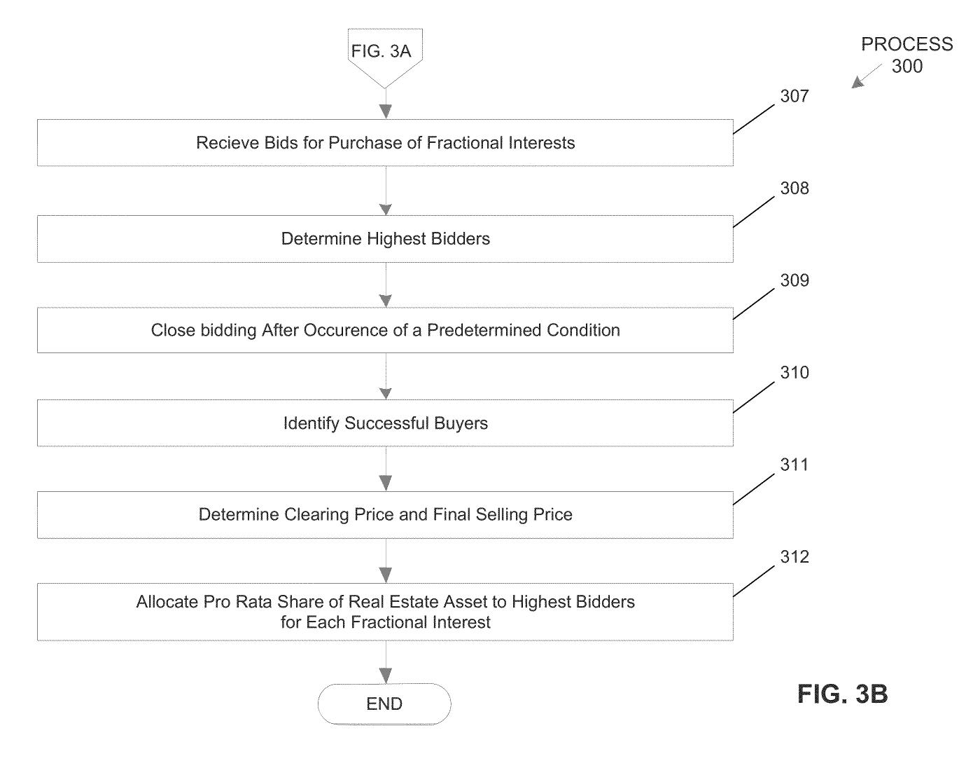

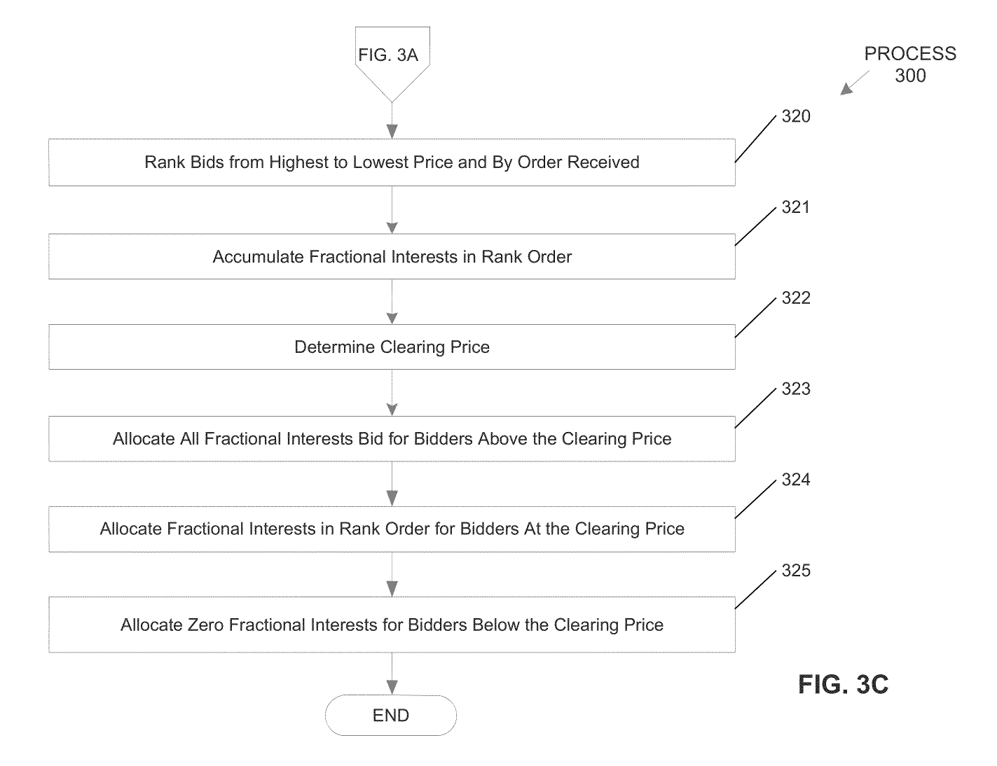

FIGS. 3A-3C depict flow charts of example embodiments of a process 300 for conducting real estate transactions over a network. Process 300 can be used for selling fractional interests in both primary and secondary markets. In the illustrated embodiment of FIG. 3A, process 300 begins at operation 301 by displaying the listings of real estate assets for sale on the network-based exchange platform. At operation 302, a real estate asset is subdivided into fractional interests. Sellers can determine the fractional interests of the real estate property to be offered for sale and the price of each fractional interest, (e.g., ⅓, 1/20, etc.) depending on how the seller wants to break it up. In one embodiment, the deed to the interest in the real estate asset is held in a holding entity, and the interest in the real estate asset is divided into the plurality of fractional interests by dividing the holding entity into a corresponding number of fractional interests. The holding entity can be a general partnership, limited partnership, limited liability company, corporation, or real estate investment trust, etc.

Offers for sale of fractional interests in real estate assets are received by the system and displayed along with a corresponding asking price (operation 303). Annual revenue and income of the real estate assets are also displayed to users by the system (operation 304). Buyers can access the platform and browse properties for sale and the fractional interests that are offered. At operation 305, the seller sets the reserve price for the fractional interests. In one embodiment, the reserve price is unknown to the buyers. The system then determines when oversubscription occurs and initiates an auction in response thereto (operation 306). Before oversubscription, the fractional interests are sold at the reserve price. Control of process 300 continues to the flow chart depicted in FIG. 3B.

In FIG. 3B, process 300 continues at operation 307. When oversubscription occurs and the online auction is initiated, the system can receive bids for purchase of fractional interests in the real estate asset(s) over the network. The bids include number of units for purchase as well as purchase price for those units. The bid price is usually at the reserve price. Buyers can submit bids to purchase one or more of the fractional interests based on the list price. Individual unit prices will fluctuate like an auction—all bids will be different for different investors and different fractional interests. The system determines the highest bidder for each of the fractional interests (operation 308) and bidding closes after a predetermined condition occurs (operation 309). In one embodiment, the bidding closes after expiration of a predetermined time period. In an alternate embodiment, bidding closes after any buyer bids an amount that meets or exceeds the reserve price set by the seller. As discussed previously, in an embodiment, the reserve price is unknown to the buyers.

The system then identifies successful buyers (operation 310) and notifies them accordingly. In an embodiment, the successful buyers are those who submitted the highest bids on the fractional interests as long as those bids meet or exceed the seller's reserve price. The average selling price for the fractional interests is calculated and the clearing price is set equal to the average selling price. The system then determines the final selling price (operation 311) by adding up the clearance prices for all the individual fractional interests.

The system then allocates a pro rata share of the interest in the real estate asset to the highest bidders based on the proportional amount they contributed respectively to the final selling price (operation 312). Generally speaking, successful buyers who submit bids greater than the average selling price of the fractional interests offered for sale are granted a final fractional interest greater than the original fractional interests and successful buyers who submit bids less than the average selling price of the fractional interests offered for sale are granted a final fractional interest less than the original fractional interests. The fractional interest in the real estate asset includes the right to a proportional amount of income generated by the fractional interest of the real estate asset.

As discussed above, the same process can be used for buyers to liquidate their assets through secondary markets. The buyers' fractional interests accrue value as the value of the overall property accrues. After the securities holding period expires (typically 6-9 months), buyers can then cash out their interest if they want by offering their fractional interest for sale using the same network-based exchange platform and the process repeats. Sellers could also divide up their fractional interest into further fractional interests.

An example of determining successful buyers and the pro rata share of each successful buyer is shown in Tables 1 and 2 below. In Table 1, a real estate asset valued at $2 million is listed for sale. The interest in this real estate asset being offered is 50% with a corresponding sale value of $1 million. The number of sub-divided fractional interests being offered on the 50% interest is three (3) units, with each unit valued at $333,333. The unit percentage of the overall real estate asset is therefore 16.67%. In this example, the seller's reserve price is set to be equal to the value of each unit at $333,333. But this value can be set to different values as determined by the seller.

TABLE 1
Bidding System Example

| | | | |
|---|---|---|---|
| Property Value: | $2,000,000 | | |
| Sale: | 50% | | |
| Sale Value: | $1,000,000 | | |
| Units: | 3 | | |
| Unit Value: | $333,333 | Reserve price | $333,333 |
| Unit percentage: | 16.67% | | |

Table 2 depicts an example showing how winning bids are determined and how each successful buyer is allocated his or her pro rata share.

TABLE 2
Bidding System Example

| Bids: | 5 |
|---|---|
| Bid 1 | $500,000 |
| Bid 2 | $350,000 |
| Bid 3 | $400,000 |
| Bid 4 | $333,333 |
| Bid 5 | $333,333 |
| Average: | $383,333 |

| Winning bids: | Interest in 50% | % in Building |
|---|---|---|
| 1 | 40% | 20.0% |
| 2 | 28% | 14.0% |
| 3 | 32% | 16.0% |
| | | 50.0% |
| Net to Seller: | $1,250,000 | |

In this example, there were five (5) bids received with each bid meeting or exceeding the seller's reserve price of $333,333 and with an average bid amount was $383,333. Since there were only three (3) units offered, the top 3 bidders are determined to be the highest bidders. The final selling price is calculated to be $1,250,000 by adding up the top three bids ($500 k, $400 k, and $350 k). The pro rata share of each successful bidder is then determined based on the respective percentage amount contributed. In this case, bidder 1 offered an amount equal to 40% of the final sale price, bidder 2 offered an amount equal to 28%, and bidder 3 offered an amount equal to 32%. Each successful buyer's pro rata share in the 50% interest offered is determined accordingly (20%, 14%, and 16% respectively).

In FIG. 3C process 300 continues at operation 320. When oversubscription occurs and the online auction is opened to receive bids, the system begins ranking the bids from highest to lowest price and by order received for bids of equal price (operation 320). Process 300 continues by accumulating fractional interests in rank order (operation 321) until all fractional interests in the offer for sale are accumulated. The price at which the last fractional interest was accumulated becomes the clearing price (operation 322). Fractional interests are then allocated according to the allocation scheme whereby all fractional interests are allocated to bidders who bid above the clearing price (operation 323), the fractional interests are allocated in rank order for bidders who bid at the clearing price (operation 324), and no fractional interests are allocated for bidders who bid below the clearing price (operation 325). Everyone who bids above the clearing price receives a full allocation. Everyone who bids at the clearing price can receive a full or partial allocation of fractional interests depending on how many fractional interests are outstanding and the time when order(s) were placed. Bidders below the clearing price are granted nothing. Refunds can be provided for deposits from bidders for amounts exceeding the clearing price. In addition, highest bidders can be granted an option to purchase a maximum number of fractional interests their associated total purchase price can buy. Bidders may also be permitted to increase the number and purchase price of fractional interests bid for during a subscription period.

Table 3 below depicts an example showing how to determine price and allocation of fractional interests in an offer for sale.

TABLE 3

| | bidder 1 | bidder 2 | bidder 3 | bidder 4 | bidder 5 | bidder 6 | bidder 7 | bidder 8 | bidder 9 | bidder 10 |
|---|---|---|---|---|---|---|---|---|---|---|
| Initial Bid | $25,000 | $26,000 | $24,000 | $23,250 | $24,000 | $26,000 | $24,000 | $23,250 | $27,000 | $27,500 |
| # of Units | 30 | 6 | 6 | 6 | 6 | 22 | 15 | 35 | 21 | 14 |
| Initial Bid Yield | 6.00% | 5.77% | 6.25% | 6.45% | 6.25% | 5.77% | 6.25% | 6.45% | 5.56% | 5.45% |
| Total Initial Bid | 750,000 | 156,000 | 144,000 | 139,500 | 144,000 | 572,000 | 360,000 | 813,750 | 405,000 | 385,000 |
| Sum Of Shares | 30 | 36 | 42 | 18 | 24 | 46 | 61 | 96 | 111 | 125 |
| What Is The | $25,000 | $26,000 | $24,000 | at reserve | $24,000 | $26,000 | $24,000 | at reserve | $27,000 | $27,500 |
| Highest Clearing | | | | | | | | | | |
| Price? | | | | | | | | | | |
| Number Of Units | 30 | 6 | 6 | 0 | 6 | 22 | 15 | 0 | 21 | 14 |
| Cum Number of | 30 | 36 | 42 | 42 | 48 | 70 | 85 | 85 | 106 | 120 |
| Units Above | | | | | | | | | | |
| Reserve | | | | | | | | | | |

In the example of Table 3, the property value is input by the seller at $9.3 M, the total number of fractional units offered is 120, and the reserve per unit pricing based on the seller's input property value is $23,250. A minimum unit purchase per buyer is also set at two (2) units. Each bid includes an Initial Bid Price and Number of Units bid for. This yields a Total Initial Bid for each bidder 1-10. The bids are ranked from highest to lowest bid price and bids of equal value are ranked in the order the bids were placed with the system. In this case, bidders 1-3, 5-7 and 9-10 bid above the reserve price and receive allocation of all the fractional interests they bid for. Bidders 4 and 8 only bid at the reserve price of $23,250 and will not receive any units because they bid below the clearing price. The Highest Clearing Price is determined by allocating fractional interests bid for each successive bid in descending rank order starting from highest price until all the fractional interests being offered for sale have been allocated. In this case, the highest clearing price is $24,000. The resulting allocation includes: 14 units at $27,500 (bidder 10); 21 units at $27,000 (bidder 9); 6 units at $26,000 (bidder 2); 22 units at $26,000 (bidder 6); 30 units at $25,000 (bidder 1); 6 units at $24,000 (bidder 3); 6 units at $24,000 (bidder 5); and 5 units at $24,000 (bidder 7). Bidders 4 and 8 receive no allocated units.

Table 4 below depicts an example showing how to determine price and allocation of fractional interests in an offer for sale. As above, in the example of Table 4, the property value is input by the seller at $9.3 M, the total number of fractional units offered is 120, and the reserve per unit pricing based on the seller's input property value is $23,250.

TABLE 4

| | bidder 1 | bidder 2 | bidder 3 | bidder 4 | bidder 5 | bidder 6 | bidder 7 | bidder 8 | bidder 9 | bidder 10 |
|---|---|---|---|---|---|---|---|---|---|---|
| Initial Bid | $25,000 | $26,000 | $24,000 | $23,250 | $24,000 | $26,000 | $24,000 | $23,250 | $27,000 | $27,500 |
| # of Units | 30 | 6 | 6 | 6 | 6 | 22 | 15 | 35 | 15 | 14 |
| Initial Bid Yield | 6.00% | 5.77% | 6.25% | 6.45% | 6.25% | 5.77% | 6.25% | 6.45% | 5.56% | 5.45% |
| Total Initial Bid | 750,000 | 156,000 | 144,000 | 139,500 | 144,000 | 572,000 | 360,000 | 813,750 | 405,000 | 385,000 |
| Sum Of Shares | 30 | 36 | 42 | 18 | 24 | 46 | 61 | 96 | 111 | 125 |
| What Is The | $25,000 | $26,000 | $24,000 | at reserve | $24,000 | $26,000 | $24,000 | at reserve | $27,000 | $27,500 |
| Highest Clearing | | | | | | | | | | |
| Price? | | | | | | | | | | |
| Number Of Units | 30 | 6 | 6 | 0 | 6 | 22 | 15 | 0 | 15 | 14 |
| Cum Number of | 30 | 36 | 42 | 42 | 48 | 70 | 85 | 85 | 100 | 114 |
| Units Above | | | | | | | | | | |
| Reserve | | | | | | | | | | |

In this example, bidder 9 only bid for 15 units. The property is thus undersold but nevertheless oversubscribed. In this case, all of the units are sold at the reserve price to the buyers according to the ranking of bids. This results in the remaining 6 units being allocated to bidder 4 at the reserve price.

This completes process 300 according to one example embodiment.

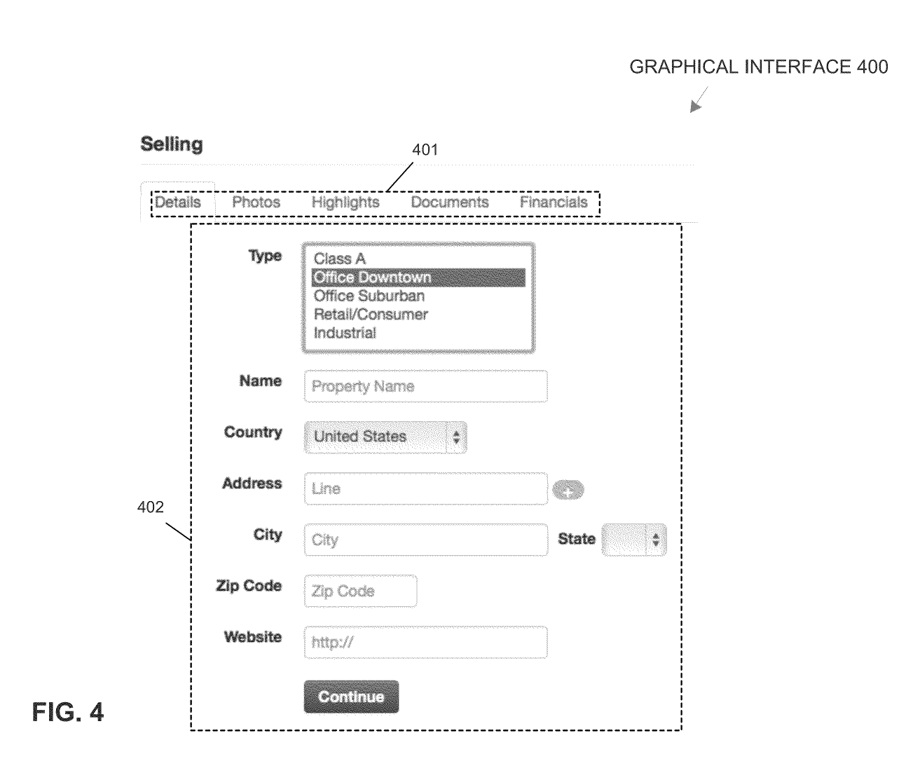

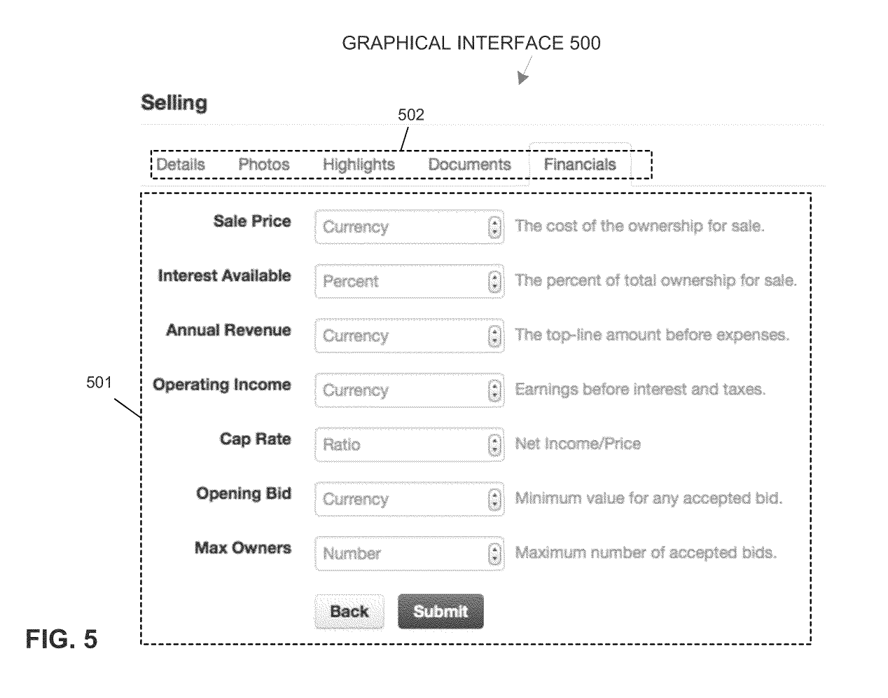

Embodiments of a graphical interface displayed to users 250 for entering sales information over the network 200 are depicted in FIGS. 4 and 5. The sales information can include name and address of the real estate asset, website featuring the asset, asking sale price, interest available, annual revenue, operating income, opening bid, maximum number of investors, etc. Referring to of FIG. 4, graphical interface 400 includes tabs 401 for navigating the sales information in various different displays. In the illustrated embodiment, the details tab of tabs 401 is selected. This display screen enables sellers to enter information 402 about the subject properties including type of property, such as Class A, Office Downtown or Suburban, Retail, or Industrial, etc. The location of the properties can also be entered in this display. In FIG. 5, graphical interface 500 includes financials information 501 about the real estate asset for sale, which is shown in the financials tab of tabs 502. The information 501 includes sale price (select currency), interest available (select percentage), annual revenue (select currency), operating income, cap rate (select ratio), opening bid, and maximum number of owners. Other financials information can be included in alternative embodiments.

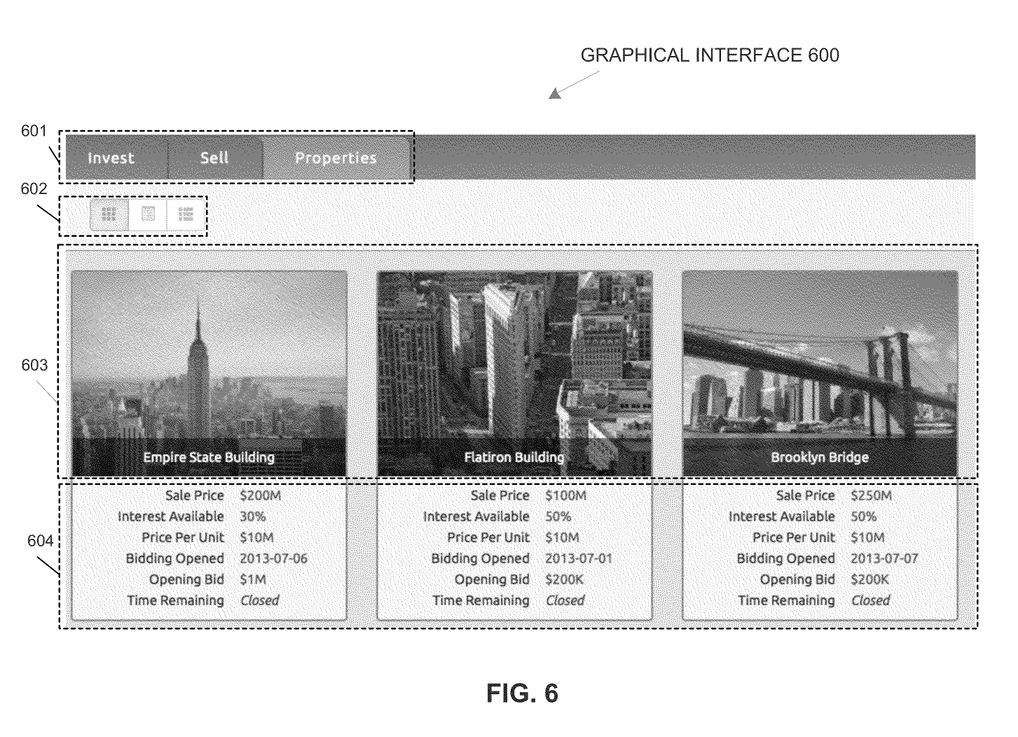

FIG. 6 depicts an example embodiment of a graphical interface for displaying information relating to an interest in a real estate asset for sale. In the illustrate embodiment, graphical interface 600 includes photographs of the real estate assets for sale 603 along with corresponding information 604 relating to each property. Such information may include sale price, interest available, etc. The display also includes tabs 601, in which the properties tab is selected. The display also includes selector tabs 602 for users to toggle between different detailed views of the subject properties. Clicking on the selector tabs 602 can drill further down into the details of the subject properties for sale.

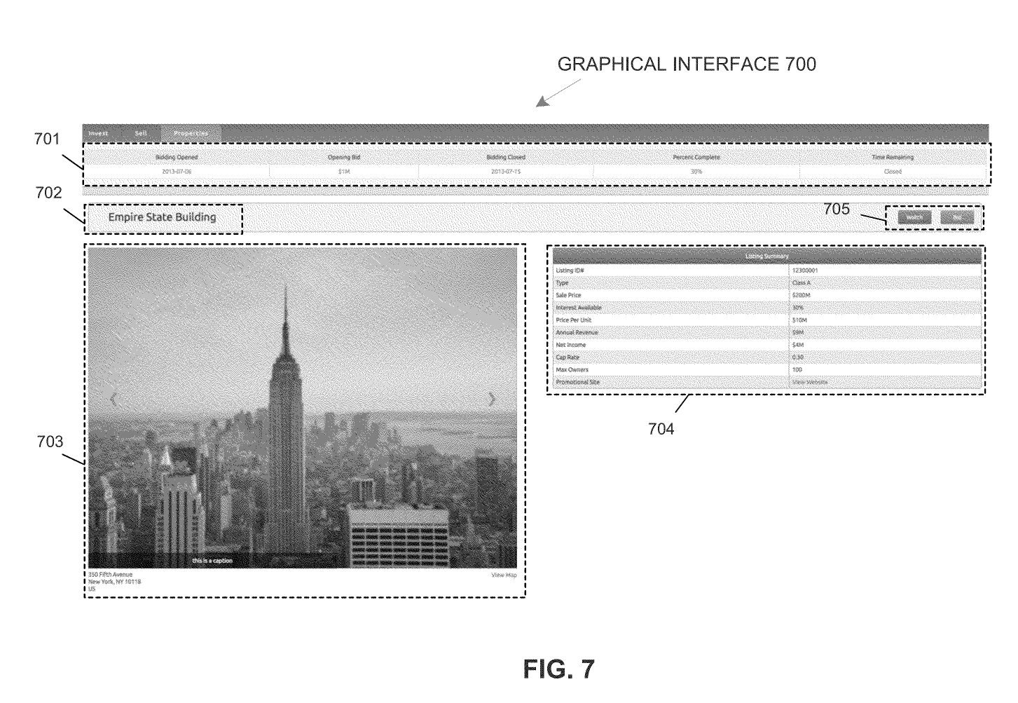

FIG. 7 depicts an example embodiment of a graphical interface for displaying more detailed information relating to a real estate asset for sale. Graphical interface 700 includes the name of the real estate asset for sale 702 along with various bidding information 701 including data bidding opened, opening bid amount, data bidding closed, percentage of property available, and time remaining for buyers to bid. Graphical interface 700 also includes a photograph of the property 703 and detailed information about the property 704. Further, tabs 705 are provided to give users the option to follow (“watch”) a property and receive notifications relating to it, or to enter bids on the property.

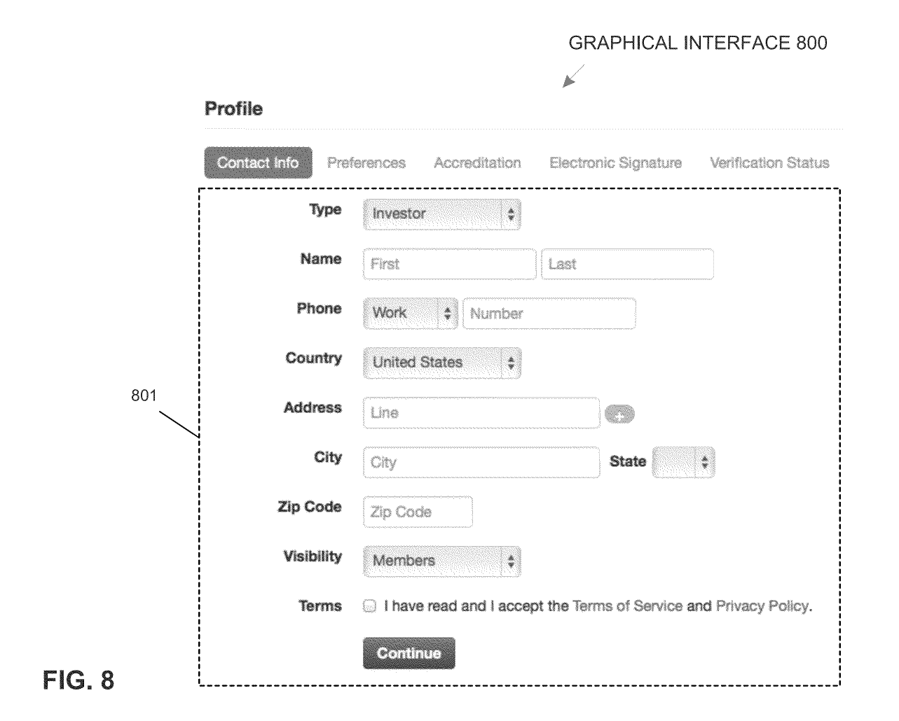

User profile information can be entered by users 250 of the system and received at network interface 202 of transaction server 205. In one embodiment, the user profile information includes buyer profile information. Buyers can include investors, companies, owners, agents or brokers, etc. The buyer profile information received at network interface 202 is provided to a user profile module 204 for further processing and eventual storage in database 207. The buyer profile information can include buyer type, name and contact information of the buyer, current owned properties, investments and valuations, level of acceptable risk for the buyer, time horizon, gross income, and net worth, etc. FIG. 8 depicts an example embodiment of a graphical interface for collecting buyer profile information. In the illustrated embodiment, graphical interface 800 facilitates entry of buyer contact information 801. This information can include whether the buyer is an investor, owner or corporation, and the contact information of the buyer. This information can be accumulated by the network-based exchange and used for conducting transactions over a network.

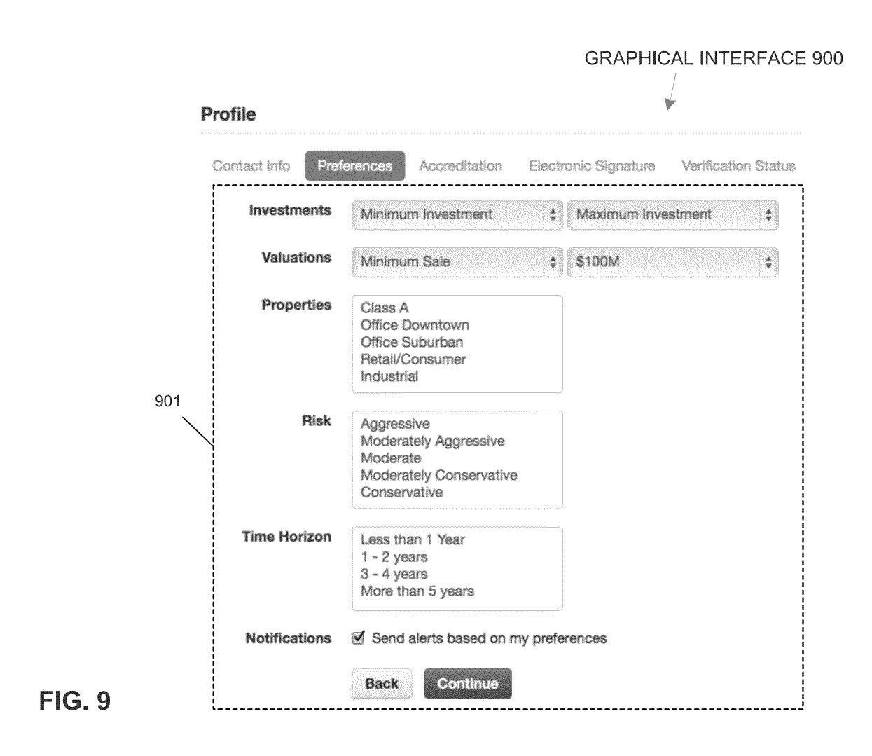

FIG. 9 depicts an example embodiment of a graphical interface for collecting buyer preferences information. In the illustrated embodiment, the buyer preferences information 901 of graphical interface 900 includes investment minimums and maximums, valuations, types of properties, desired risk level, time horizon, etc. The buyer preferences information can also be used by the system when conducting real estate transactions. FIG. 10 depicts an example embodiment of a graphical interface for collecting buyer accreditation information. In the illustrated embodiment, the buyer accreditation information 1001 of graphical interface 1000 includes income, income source, net worth, total current investments, etc. As discussed previously, buyers must be accredited, and generally provide a deposit, in order to successfully bid on fractional interests in properties.

The buyer profile information can then be entered into a file or database in a table format such as that shown below in Table 5.

TABLE 5

| | |
|---|---|
| Account Type | Investor |
| Name | Shawn Silk |
| Phone | 415-415-4155 |
| Residence Address | 2121 Weston Drive, Rio Rancho, CA 94010 |
| Mailing Address | 2121 Weston Drive, Rio Rancho, CA 94010 |
| Email Address | shawn@barnesandnoble.com |
| DOB | 1975-01-19 |
| Income Source | Individual |
| Annual Income | $500K+ |
| Net Worth | Less than $1M |
| Total Investments | Less than $1M |
| Investment Time | More than 5 years |
| Risk Level | Aggressive |
| Min Objective | $50K |
| Max Objective | $500K |
| Terms | True |
| Investment Type | {“class_a” = “1”, |
| | “office_downtown”,“office suburban” = “1”} |
| Signature | /s/ Shawn Silk |
| Signature Date | 2013-03-03 |
| UserID | #<User: 0xbc752b70> |

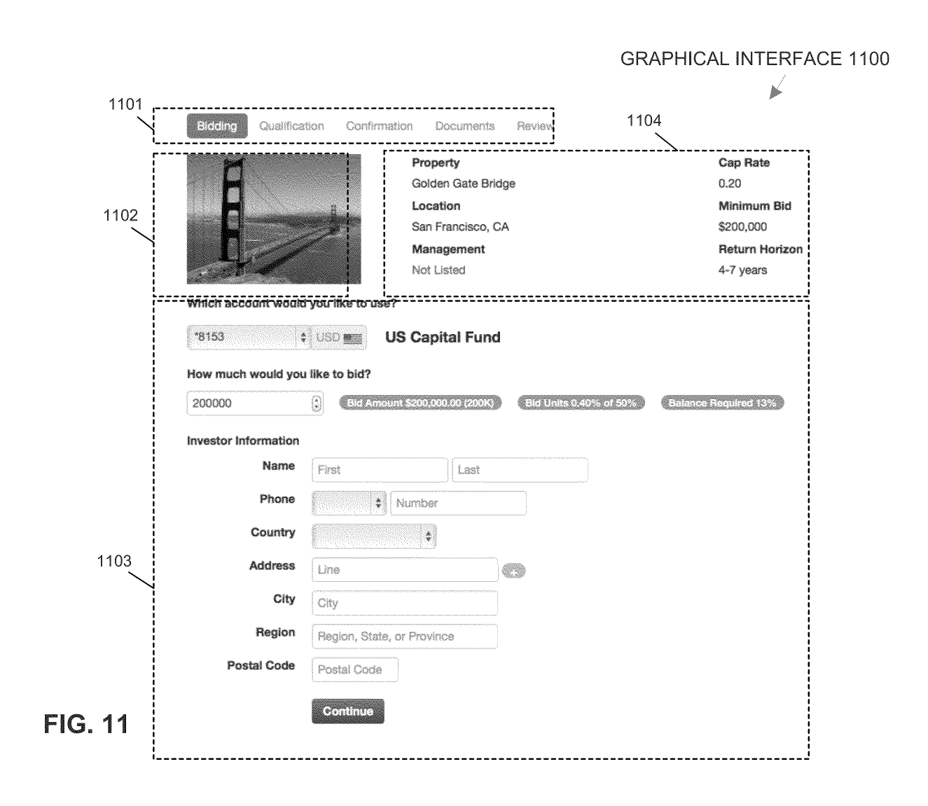

Once the information about the real estate properties and buyer profiles are entered into the system, it can begin the bidding process of purchase of fractional interests of these properties. FIG. 11 depicts an example embodiment of a graphical interface for collecting bidding information. In the illustrated embodiment, graphical interface 1100 includes tabs 1101 for users to navigate the various display screens for the bidding process. Graphical interface 1100 includes a photograph of the subject property 1102 and associated information about the property 1104. It also includes the bidding information 1103, which generally includes bid amount and investor information.

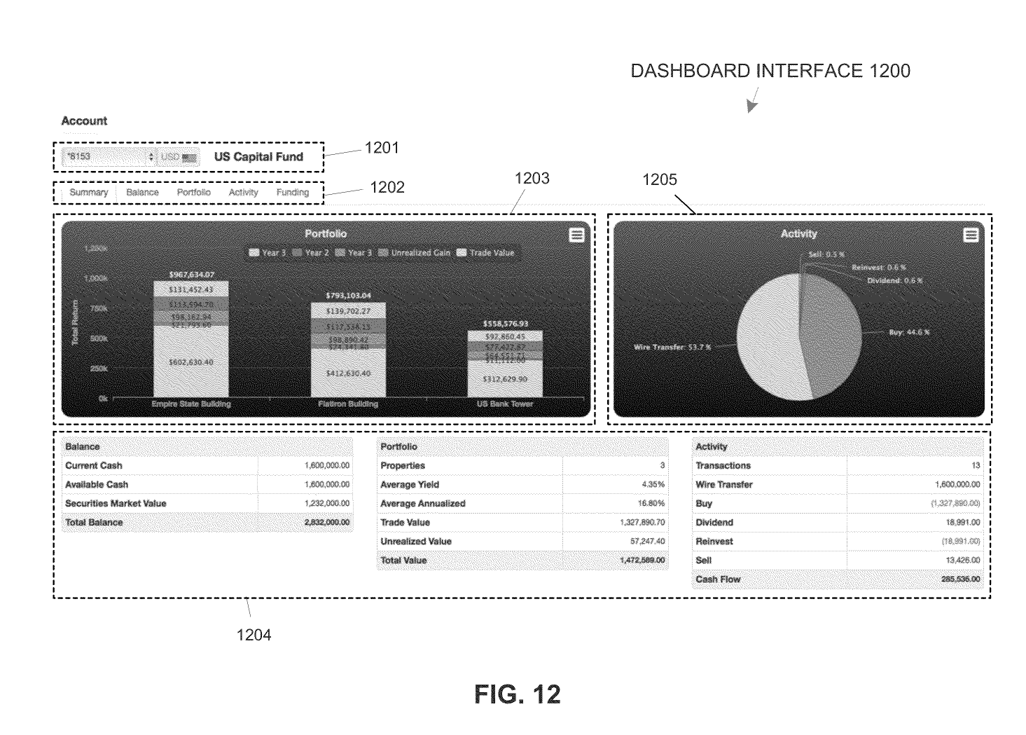

FIG. 12 depicts an example embodiment of a user account dashboard interface. The dashboard interface provides an overview of holdings and accounts of users in one convenient and user-friendly location. In the illustrated embodiment, dashboard interface 1200 includes an account selection menu 1201 to enable users to possess more than one account and to toggle between them as desired. Dashboard interface 1200 includes detailed displays of information associated with the selected user account such as a portfolio display 1203 and an activity display 1205. Dashboard interface 1200 further includes detailed user account information 1204 including account balances, portfolio, and activity. The dashboard interface 1200 also includes selection tabs 1202 to enable users to display various different graphical representations of the detailed user account information including account summary, balance, portfolio, activity, and funding, etc.

The embodiments described herein include a network-based method and system for conducting a real estate auction. It should be understood that the various data processing devices and systems are provided for illustrative purposes only, and are not intended to represent any particular architecture or manner of interconnecting components, as such details are not germane to the techniques described herein. It will be appreciated that network computers and other data processing systems, which have fewer components or perhaps more components, may also be used. For instance, these embodiments may be practiced with a wide range of computer system configurations including any device that can interact with the Internet via a web browser or an application such as computer systems, workstations, personal computers (“PCs”), Macintosh computers, programmable consumer electronics, minicomputers, mainframe computers, or any mobile communications device including an iPhone, iPad, Android, or Blackberry device, or any device having similar functionality. These embodiments can also be practiced in distributed computing environments where tasks are performed by remote processing devices that are linked through a wire-based or wireless network.

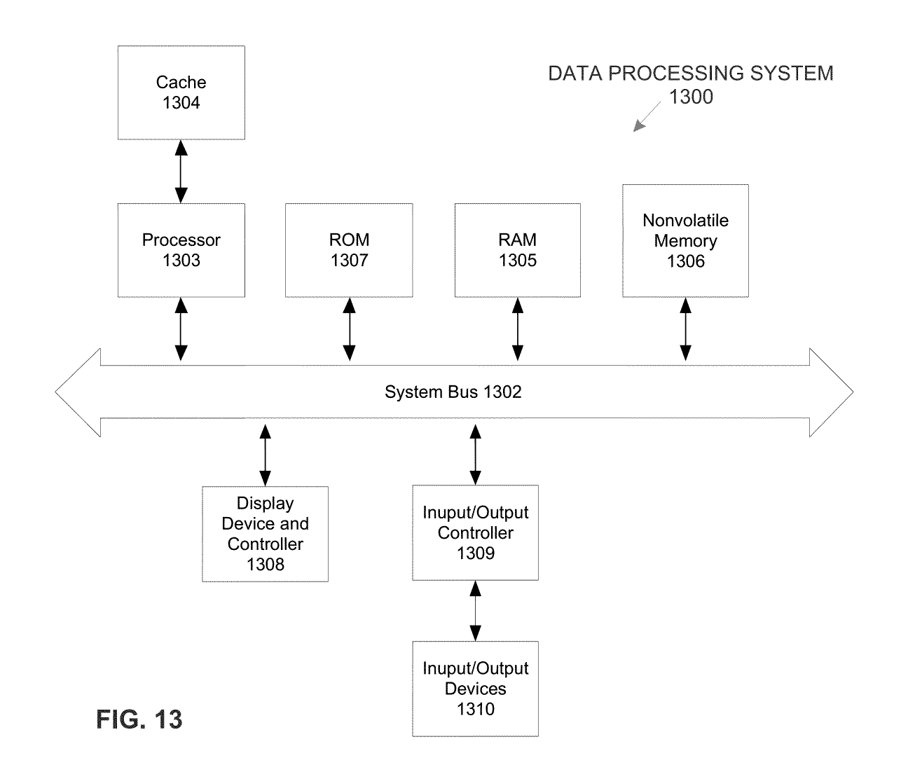

FIG. 13 depicts an example data processing system upon which the embodiments described herein may be implemented. As shown in FIG. 13, the data processing system 1301 includes a system bus 1302, which is coupled to a processor 1303, a Read-Only Memory (“ROM”) 1307, a Random Access Memory (“RAM”) 1305, as well as other nonvolatile memory 1306, e.g., a hard drive. In the illustrated embodiment, processor 1303 is coupled to a cache memory 1304. System bus 1302 can be adapted to interconnect these various components together and also interconnect components 1303, 1307, 1305, and 1306 to a display controller and display device 1308, and to peripheral devices such as input/output (“I/O”) devices 1310. Types of I/O devices can include keyboards, modems, network interfaces, printers, scanners, video cameras, or other devices well known in the art. Typically, I/O devices 1310 are coupled to the system bus 1302 through I/O controllers 1309. In one embodiment the I/O controller 1309 includes a Universal Serial Bus (“USB”) adapter for controlling USB peripherals or other type of bus adapter.

RAM 1305 can be implemented as dynamic RAM (“DRAM”), which requires power continually in order to refresh or maintain the data in the memory. The other nonvolatile memory 1306 can be a magnetic hard drive, magnetic optical drive, optical drive, DVD RAM, or other type of memory system that maintains data after power is removed from the system. While FIG. 13 shows that nonvolatile memory 1306 as a local device coupled with the rest of the components in the data processing system, it will be appreciated by skilled artisans that the described techniques may use a nonvolatile memory remote from the system, such as a network storage device coupled with the data processing system through a network interface such as a modem or Ethernet interface (not shown).

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a computer system. The techniques may be carried out in a computer system or other data processing system in response executing sequences of instructions stored in memory. In various embodiments, hardwired circuitry may be used independently or in combination with software instructions to implement these techniques. For instance, the described functionality may be performed by specific hardware components containing hardwired logic for performing operations, or by any combination of custom hardware components and programmed computer components. The techniques described herein are not limited to any specific combination of hardware circuitry and software.

Embodiments herein may also be implemented in computer-readable instructions stored on an article of manufacture referred to as a computer-readable medium, which is adapted to store data that can thereafter be read and processed by a computer. Computer-readable media is adapted to store these computer instructions, which when executed by a computer or other data processing system such as data processing system 1300, are adapted to cause the system to perform operations according to the techniques described herein. Computer-readable media can include any mechanism that stores information in a form accessible by a data processing device such as a computer, network device, tablet, smartphone, or any device having similar functionality. Examples of computer-readable media include any type of tangible article of manufacture capable of storing information thereon including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing instructions in an electronic format. Computer-readable media can also be distributed over a network-coupled computer system stored and executed in a distributed fashion.

Throughout the foregoing description, for the purposes of explanation, numerous specific details were set forth in order to provide a thorough understanding of the invention. It will be apparent, however, to persons skilled in the art that these embodiments may be practiced without some of these specific details. Although various embodiments incorporating the teachings of the present invention have been shown and described in detail herein, those skilled in the art can readily devise many other varied embodiments that still incorporate these techniques. Embodiments of the invention may include various operations as set forth above or fewer operations or more operations; or operations in an order, which is different from the order described herein. Accordingly, the scope and spirit of the invention should be judged in terms of the claims that follow as well as the legal equivalents thereof.

What is claimed is:

1. A method of conducting a real estate auction in a network, the method comprising:
receiving an offer for sale of a prescribed number of fractional interests in a real estate asset at a data processing server configured to process real estate transactions;
receiving offers for purchase of one or more of the fractional interests at the data processing server;
determining whether oversubscription has occurred, wherein oversubscription occurs when offers for purchase of the fractional interests at or above a reserve price exceed the prescribed number of fractional interests being offered for sale;
receiving bids for purchase of the fractional interests in the real estate asset when oversubscription has occurred;
selling the fractional interests to successful bidders at a clearing price when oversubscription has occurred; and
selling the fractional interests to successful bidders at the reserve price when oversubscription has not occurred.

2. The method of claim 1 further comprising:
determining highest bidders for each of the fractional interests after bidding closes;
calculating an average selling price of the fractional interests using processing circuitry of the data processing server;
setting the clearing price for purchase of the fractional interests equal to the average selling price; and
calculating a final selling price of the real estate asset by adding up the clearing prices for each of the fractional interests using the processing circuitry;
allocating a pro rata share of interest in the real estate asset to each highest bidder based on a proportional amount they contributed to the final selling price, wherein highest bidders submitting bids greater than the clearing price of the fractional interests are granted a final fractional interest greater than the prescribed fractional interests, and highest bidders submitting bids less than the clearing price of the fractional interests are granted a final fractional interest less than the prescribed fractional interests.

3. The method of claim 2 further comprising only allocating fractional interests to highest bidders bidding an amount above the reserve price.

4. The method of claim 2 further comprising transferring final fractional interests into a sub-entity to be further subdivided into a second prescribed number of fractional interests for sale in a secondary market.

5. The method of claim 1 further comprising:
ranking bids from highest price to lowest price and ranking bids of equal price in the order received;
accumulating fractional interests bid for each successive bid in descending rank order starting from highest price until all the fractional interests being offered for sale have been accumulated;
setting a clearing price for purchase of the fractional interests equal to a price of the last fractional interest accumulated;
allocating, to bidders bidding a price above the clearing price, all fractional interests bid; and
allocating, to bidders bidding a price below the clearing price, zero fractional interests.

6. The method of claim 5 further comprising allocating, to bidders bidding a price equal to the clearing price, all fractional interests bid in rank order until all fractional interests being offered for sale have been allocated.

7. The method of claim 5 further comprising refunding bidders for purchase price deposits over the clearing price.

8. The method of claim 1 further comprising granting highest bidders an option to purchase a maximum number of fractional interests for an associated total purchase price.

9. The method of claim 1 further comprising setting an initial price range in which bid must be within or setting a minimum reserve price bids must be above.

10. The method of claim 1 wherein bids include the number of fractional interests a potential purchaser would be willing to purchase and the price per fractional interest such potential purchaser would be willing to pay.

11. The method of claim 1 wherein bidders are permitted to increase number and purchase price of fractional interests bid for during a subscription period.

12. The method of claim 1 wherein the reserve price is based on the value of the real estate asset and the number of fractional interests being offered.

13. The method of claim 1 wherein the reserve price is based on a minimum amount of capital to fundraise.

14. The method of claim 1 wherein deed to the interest in the real estate asset is held in a holding entity and the interest in the real estate asset is subdivided into the fractional interests by subdividing the holding entity into a corresponding number of factional interests.

15. The method of claim 14 wherein the holding entity is one of a general partnership, limited partnership, limited liability company, corporation, or real estate investment trust (“REIT”).

16. The method of claim 1 wherein ownership of a fractional interest in the real estate asset includes a right to a proportional amount of income generated by the fractional interest.

17. A system for conducting a real estate auction in a network comprising:
(1) a processing unit;
(2) a memory operatively coupled with the processing unit through an interconnect;
(3) a network interface configured to communicate with a plurality of electronic devices in the network, wherein the network interface is adapted to:
receive an offer for sale of a prescribed number of fractional interests in a real estate asset;
receive offers for purchase of one or more of the fractional interests from prospective buyers;
(4) a auction engine operatively coupled with the processing unit and configured to:
determine whether oversubscription has occurred, wherein oversubscription occurs when offers for purchase of the fractional interests at or above a reserve price exceed the prescribed number of fractional interests being offered for sale;
receive bids for purchase of the fractional interests in the real estate asset when oversubscription has occurred;
sell the fractional interests to successful bidders at a clearing price when an oversubscription event has occurred; and
sell the fractional interests to successful bidders at the reserve when an oversubscription even has not occurred.

18. The system of claim 17 wherein the auction engine is further configured to:
determine highest bidders for each of the fractional interests after bidding closes;
calculate an average selling price of the fractional interests using processing circuitry of the data processing server;
set the clearing price for purchase of the fractional interests equal to the average selling price; and
calculate a final selling price of the real estate asset by adding up the clearing prices for each of the fractional interests using the processing circuitry;
allocate a pro rata share of interest in the real estate asset to each highest bidder based on a proportional amount they contributed to the final selling price, wherein highest bidders submitting bids greater than the clearing price of the fractional interests are granted a final fractional interest greater than the prescribed fractional interests, and highest bidders submitting bids less than the clearing price of the fractional interests are granted a final fractional interest less than the prescribed fractional interests.

19. The system of claim 17 wherein the auction engine is further configured to:
rank bids from highest price to lowest price and rank bids of equal price in the order received;
accumulate fractional interests bid for each successive bid in descending rank order starting from highest price until all the fractional interests being offered for sale have been accumulated;
set a clearing price for purchase of the fractional interests equal to a price of the last fractional interest accumulated;
allocate, to bidders bidding a price above the clearing price, all fractional interests bid; and
allocate, to bidders who bid a price below the clearing price, zero fractional interests.

20. The system of claim 19 wherein the auction engine is further configured to allocate, to bidders bidding a price equal to the clearing price, all fractional interests bid in rank order until all fractional interests being offered for sale have been allocated.

21. The system of claim 17 wherein bids include the number of fractional interests a potential purchaser would be willing to purchase and the price per fractional interest such potential purchaser would be willing to pay.

22. The system of claim 17 wherein bidders are permitted to increase number and purchase price of fractional interests bid for during a subscription period.

23. The system of claim 17 wherein the reserve price is set based on the value of the real estate asset and the number of fractional interests being offered.

24. The system of claim 17 wherein the reserve price is set based on a minimum amount of capital to fundraise.

25. The system of claim 17 wherein deed to the interest in the real estate asset is held in a holding entity and the interest in the real estate asset is subdivided into the fractional interests by subdividing the holding entity into a corresponding number of factional interests.

26. The system of claim 25 wherein the holding entity is one of a general partnership, limited partnership, limited liability company, corporation, or real estate investment trust (“REIT”).

27. The system of claim 17 further comprising a transaction-closing unit configured to close bidding on the fractional interests after a predetermined period of time.

28. The system of claim 17 further comprising a database accessible to the system configured to store electronic records of offers for sale of interests in real estate assets.

29. The system of claim 17 further comprising a cash flow distribution unit configured to distribute income generated by the fractional interests to successful buyers thereof based on respective pro rata shares.
